(19) United States
(12) Patent Application Publication
(10) Pub. No.: US 2007/0271591 A1
(43) Pub. Date: Nov. 22, 2007

(54) VIEWING/LISTENING INFORMATION COLLECTING SERVER, A VIEWING/LISTENING INFORMATION COLLECTING METHOD, AND VIEWING/LISTENING INFORMATION TRANSMITTING PROGRAM

(75) Inventors: Yuuji Izumi, Tokyo (JP); Kozo Banno, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/682,474

(22) Filed: Mar. 6, 2007

(30) Foreign Application Priority Data
May 18, 2006 (JP) 2006-138675

(51) Int. Cl. H04N 7/16

(52) U.S. Cl. 725/135

(57) ABSTRACT

A portable communication terminal is provided with the viewing/listening information transmitting program for generating and transmitting viewing/listening information. The viewing/listening information generated according to the viewing/listening information transmitting program is collected from a portable communication terminal. The broadcast station is specified from the collected viewing/listening information. And viewing/listening rate information is generated from the viewing/listening information.

### CROSS REFERENCE TO RELATED APPLICATIONS

This application is based on and claims the benefit of priority from prior Japanese Patent Application No. 2006-138675, filed on May 18, 2006, the entire contents of which are incorporated herein by reference

### BACKGROUND OF THE INVENTION

1. Field of the Invention

The present invention relates to a viewing/listening information collecting server and a viewing/listening information collecting method collecting viewing/listening information indicating a viewing/listening mode of a terrestrial digital broadcasting, from a portable terminal device enabled to receive a terrestrial digital broadcasting from a broadcast station, and a viewing/listening information transmitting program for transmitting viewing/listening information.

2. Description of the Related Art

Various technologies or models have been proposed as systems for performing a viewing/listening rate survey of each program broadcasted on television (see JP2005-229302A, JP2005-176067A, JP2005-26779A, and JP2005-229221A).

For example, JP2005-229302A discloses collecting viewing/listening information corresponding to viewing/listening of a TV broadcasting on an information-processing terminal. Moreover, JP2005-176067A discloses collecting viewing/listening information about viewing/listening of a TV program on a portable terminal by cellular-phone communication companies.

Furthermore, JP2005-26779A discloses collecting viewing/listening information about viewing/listening of a TV broadcasting on a portable terminal, by offering a list of broadcast stations judged from the present position information that viewing/listening thereof are possible, and registering and transmitting viewing/listening information by a user's input.

Furthermore, JP2005-229221A discloses that a portable terminal enabled to receive a TV broadcasting is used as a remote controller for a TV receiver or a DVD recorder, and viewing/listening rate information is collected from the remote controller.

In Japan, terrestrial digital broadcasting for portable terminal devices called “one-segment broadcasting”, which uses one segment, has been started since April 2006.

The one-segment broadcasting is obligated to simultaneously broadcast the same content as high-definition television broadcasting using 12 segments (received on digital TVs). That is, although resolution is less because it is for portable terminal devices, the same advertisements that have been provided on TV broadcasting are automatically offered to portable terminal devices.

It is possible to deal with a viewing/listening rate survey including viewing/listening of one-segment broadcasting, by substituting a result of a viewing/listening rate survey on current household TV devices. However, it is expected that a start of one-segment broadcasting will change viewing/listening environments greatly as compared with viewing/listening only with the current household TV devices. Accordingly, when viewers on portable terminal devices increase in number, it is also expected that the viewing/listening rates differ greatly.

Furthermore, since all of the broadcast stations in Japan will renew their licenses in 2008, it is highly possible that arguments on legal revision will be raised. Then, it is highly possible that the one-segment broadcasting will be allowed to create unique programs and unique advertisements. In this case, it is expected that a viewing/listening rate survey on an one-segment broadcasting will be necessary, since it will be a basis of cooperate incomes for a broadcast station.

Moreover, the number of sample houses in Kanto, Kansai, and Nagoya area in the current viewing/listening rate survey is only 600. For this reason, the viewing/listening rate shown as a result of the current viewing/listening rate survey includes a considerable error. This is rough or sloppy as marketing data.

In current viewing/listening rate surveys, viewers are chosen at random by an viewing/listening rate survey company in Kanto area, Kansai area and so forth (600 households in Kanto, Kansai, and the Nagoya area, 200 in other area). When the approval of the household is obtained, the company installs a device for viewing/listening rate survey on its TV receiver. Thereby, the broadcast station as a viewing object may be surveyed.

In the case of household TV devices, the current survey may be acceptable. However, when a program is viewed on a portable terminal device as viewing terminal for an one-segment broadcasting, there is a problem that there are not a method and a means to know the viewing/listening rate.

The present invention has been made in view of this problem. The object of the present invention is to collect easily viewing/listening information for computing a viewing/listening rate of a program offered from each broadcast station as terrestrial digital broadcasting, from the portable communication terminal with a viewing/listening function of terrestrial digital broadcasting.

### SUMMARY OF THE INVENTION

A viewing/listening information collecting server according to one aspect of the present invention collects viewing/listening information indicating a viewing/listening mode of terrestrial digital broadcasting, from a portable terminal device enabled to receive terrestrial digital broadcasting from a broadcast station. The server comprises a program providing unit providing the portable terminal device with a viewing/listening information transmitting program for generating and transmitting the viewing/listening information, a receiving unit receiving through a communication network the viewing/listening information generated by the viewing/listening information transmitting program in the portable terminal device, a broadcast station specification unit specifying the broadcast station of the broadcast received at the portable terminal device based on the viewing/listening information received at the receiving unit, and a storing unit storing viewing/listening result information including monitor information provided to the portable terminal device, the viewing/listening information received at the receiving unit, and the broadcast station specified by the broadcast station specification unit.

The viewing/listening information collecting server according to one aspect of the present invention provides the portable terminal device with the viewing/listening information transmitting program for generating and transmitting viewing/listening information.

The viewing/listening information generated according to the viewing/listening information transmitting program is collected from the portable terminal device. The broadcast station as an object of viewing/listening is specified from the collected viewing/listening information. The viewing/listening result information is saved.

Accordingly, the viewing/listening information for calculating a viewing/listening rate of a program provided by each broadcast station as a terrestrial digital broadcasting may be easily collected from a portable communication terminal with a function of receiving a terrestrial digital broadcasting.

The viewing/listening information may include selected channel information indicating a selected channel selected in the portable terminal device among channels to be selected as a broadcast to be received, position information indicating current position of the portable terminal device, and time information indicating current time. The broadcast station specification unit in the viewing/listening information collecting server according to the present invention may be configured to specify a broadcast station according to a selected channel indicated in the selected channel information and a current position indicated in the position information among the viewing/listening information. With this configuration, a broadcast station providing a program received at the portable terminal device may be specified easily and correctly.

The broadcast station may include a television broadcast station, and the portable terminal device may have a function of receiving a TV signal for receiving a television broadcasting With this configuration, viewing/listening information for calculating a viewing/listening rate of a TV program provided by each broadcast station as a terrestrial digital broadcasting may be easily collected from a portable communication terminal with a function of receiving a TV signal.

The broadcast station may include a radio broadcast station, and the portable terminal device has a function of receiving a radio signal for receiving a radio broadcasting. With this configuration, viewing/listening information for calculating a viewing/listening rate of a radio program provided by each broadcast station as a terrestrial digital broadcasting may be easily collected from a portable communication terminal with a function of receiving a radio signal.

The viewing/listening information collecting server according to the present invention may further comprise a calculation unit calculating a viewing/listening rate per broadcast station at a certain interval based on a plurality pieces of viewing/listening result information stored in the storing unit, and a first transmitting unit transmitting through a communication network to each of the broadcast station a viewing/listening rate list indicating a list of the viewing/listening rates calculated by the calculation unit. Thereby, a viewing/listening rate per broadcast station may be calculated, and a viewing/listening rate list indicating a list of the viewing/listening rates may be provided to each broadcast station.

The viewing/listening information collecting server according to the present invention may further comprise a determination unit determining a user as a privilege receiver among users of the portable terminal devices registered as monitors, and a second transmitting unit transmitting privilege information indicating a certain privilege to the portable terminal device used by the user decided as a privilege receiver in the determination unit. With this configuration, users registered as monitors may receive a certain privilege such as a coupon. This may be a motivation for a monitor registration, and it is expected that many users agree with a request of a monitor registration.

The viewing/listening information collecting method according to the present invention collects viewing/listening information indicating a viewing/listening mode of terrestrial digital broadcasting, from a portable terminal device enabled to receive terrestrial digital broadcasting from a broadcast station. The method comprises: a program providing step providing the portable terminal device with a viewing/listening information transmitting program for generating and transmitting the viewing/listening information; a receiving step receiving through a communication network the viewing/listening information generated by the viewing/listening information transmitting program in the portable terminal device; a broadcast station specification step specifying the broadcast station of the broadcast received at the portable terminal device based on the viewing/listening information received at the receiving step; and a storing step storing viewing/listening result information including monitor information provided to the portable terminal device, the viewing/listening information received at the receiving step, and the broadcast station specified by the broadcast station specification step.

The viewing/listening information transmitting method according to the present invention provides the portable terminal device with the viewing/listening information transmitting program for generating and transmitting viewing/listening information. The viewing/listening information generated according to the viewing/listening information transmitting program is collected from the portable terminal device. The broadcast station as an object of viewing/listening is specified from the collected viewing/listening information. The viewing/listening result information is saved. Accordingly, the viewing/listening information for calculating a viewing/listening rate of a program provided by each broadcast station as a terrestrial digital broadcasting may be easily collected from a portable communication terminal with a function of receiving a terrestrial digital broadcasting.

The viewing/listening information transmitting program according to the present invention allows a portable terminal device enabled to receive terrestrial digital broadcasting from a broadcast station to generate and transmit viewing/listening information indicating a viewing/listening mode of terrestrial digital broadcasting. The program is configured to allow the portable terminal device to execute: a generating step generating viewing/listening information that may specify a broadcast station of a broadcast received therein; and a transmitting step transmitting through a communication network the viewing/listening information generated in the generating step. The viewing/listening information transmitting program according to the present invention makes it possible to easily correct viewing/listening information for calculating a viewing/listening rate of a program provided from each broadcast station as a terrestrial digital broadcasting, from a portable communication terminal having a function of receiving a terrestrial digital broadcasting.

According to the present invention, it is possible to provide a viewing/listening information collecting server and a viewing/listening information collecting method enabled to collect easily viewing/listening information for computing a viewing/listening rate of a program offered from each broadcast station as terrestrial digital broadcasting, from the portable communication terminal with a viewing/listening function of terrestrial digital broadcasting, and a viewing/listening information transmitting program for transmitting viewing/listening information.

### BRIEF DESCRIPTION OF THE DRAWINGS

FIG. 1 is a block diagram showing the composition of the viewing/listening information collecting system concerning the first embodiment of the present invention.

FIG. 2 is a block diagram showing the composition of a viewing/listening information collecting server.

FIG. 3 is a diagram showing an example of monitor information.

FIG. 4 is a sequence diagram showing an example of a monitor information registration process.

FIG. 5 is a flowchart showing an example of a viewing/listening information transmitting process performed by a portable communication terminal.

FIG. 6 is a diagram showing an example of viewing/listening information.

FIG. 7 is a sequence diagram showing an example of a position information acquisition process.

FIG. 8 is a sequence diagram showing an example of a viewing/listening information registration process.

FIG. 9 is a sequence diagram showing an example of a viewing/listening rate information transmitting process.

FIG. 10 is a diagram showing an example of the table for broadcast station specification.

FIG. 11 is a block diagram showing a composition of the viewing/listening information collecting system concerning the second embodiment of the present invention.

FIG. 12 is a sequence diagram showing an example of a privilege delivery process.

FIG. 13 is a sequence diagram showing other examples of a viewing/listening rate information transmitting process.

FIG. 14 is a sequence diagram showing yet another example of a viewing/listening rate information transmitting process.

FIG. 15 is a flowchart showing other examples of a viewing/listening information transmitting process performed by a portable communication terminal.

FIG. 16 is a flowchart showing yet another example of a viewing/listening information transmitting process performed by a portable communication terminal.

FIG. 17 is a diagram showing other examples of viewing/listening information.

### DETAILED DESCRIPTION OF THE EMBODIMENTS

Hereafter, the viewing/listening information collecting system according to the embodiments of the present invention is explained, with reference to drawings.

### The First Embodiment

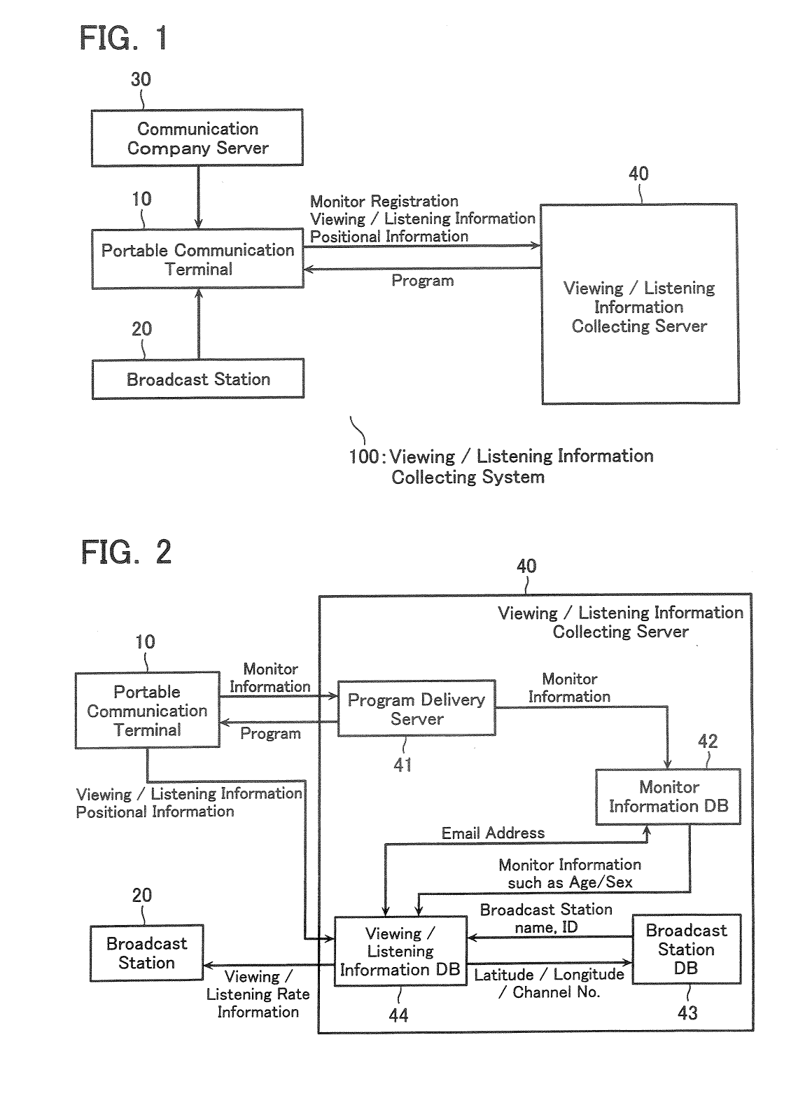

FIG. 1 is a block diagram showing an example of composition of the viewing/listening information collecting system 100 according to the first embodiment. The viewing/listening information collecting system 100 includes a portable communication terminal 10, a broadcast station 20 managed by a broadcasting company, a communication company server 30 managed by a communication company, and a viewing/listening information collecting server 40 managed by a viewing/listening rate survey company. In addition, in FIG. 1, although the portable communication terminal 10, the broadcast station 20, and the communication company server 30 are illustrated as a single one, respectively, they may be plural.

The portable communication terminal 10 is an information-processing device with movability, portability, for example, a cellular phone.

The portable communication terminal 10 has a function of obtaining and transmitting position information. It is also provided with a storage medium storing various kinds of information. It also has a function of receiving a broadcast signal of a program broadcasted by a broadcast stations 20 such as television (TV) broadcast station and a radio broadcast station (for example, a program broadcasted from an one-segment broadcast station). Here, “one-segment broadcast” means the terrestrial digital broadcasting for portable devices, such as the portable communication terminal 10.

The viewing/listening information collecting server 40 is composed of information processing devices such as a WWW server. It has a function of obtaining viewing/listening information and position information from the portable terminal device registered as a monitor in advance. The viewing/listening information collecting server 40 has various kinds of functions including transmitting viewing/listening rate information to a broadcast station. The viewing/listening information collecting server 40 performs various kinds of operation according to the viewing/listening information collecting program stored in the storage medium provided therein.

In this embodiment, the viewing/listening rate survey company operating the viewing/listening information collecting server 40 first determines monitor candidates of a viewing/listening rate survey. For example, as in a conventional TV program viewing/listening rate survey, the predetermined number of monitor candidates may be chosen at random, based on a Basic Resident Register produced by the government.

Next, among the monitor candidates, some users of portable communication terminals 10 agree with the viewing/listening rate survey request. Then, the viewing/listening rate survey company provides the portable communication terminals 10 with a special program (a viewing/listening information transmitting program) in accordance with a contract. Then, the portable communication terminal 10 used by the user provides viewing/listening information or the like automatically by the program. The viewing/listening rate survey company makes a contract with a broadcasting company, and provides a broadcasting company with viewing/listening rate information.

Next, the composition of the viewing/listening information collecting server 40 is explained. FIG. 2 is a block diagram showing an example of composition of the viewing/listening information collecting server 40. The viewing/listening information collecting server 40 includes a program delivery server 41, a monitor information database 42, a broadcast station database 43, and a viewing/listening information database 44.

The user of the portable communication terminal 10 who has agreed with the viewing/listening rate survey request accesses the program delivery server 41 first. Then, the user inputs the user information about the portable communication terminals 10, such as an e-mail address, to make a monitor contract.

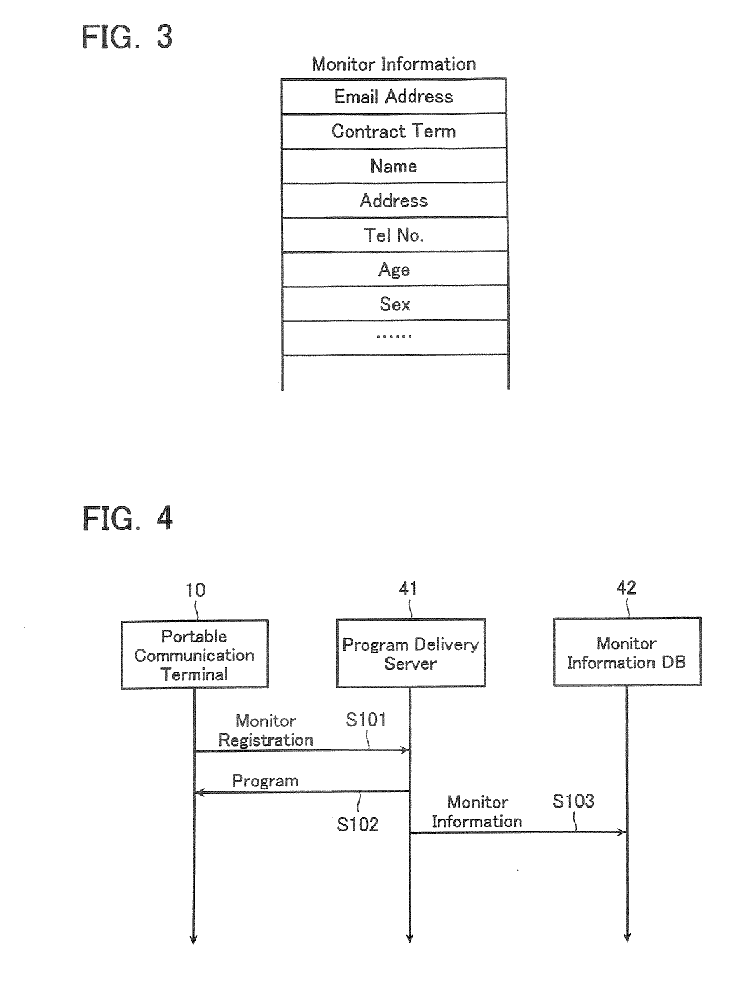

The program delivery server 41 registers the user information (monitor information: refer to FIG. 3) about the user who made the monitor contract as a cooperator (monitor) of a viewing/listening rate survey. It sends the information to the monitor information database 42, and delivers a program (viewing/listening information transmitting program) for collecting viewing/listening rate information.

The monitor information database 42 accumulates the monitor information sent from the program delivery server 41.

The monitor information is information about users registered as a monitor, such as an e-mail address for identifying a monitor, a contract term, a name, an address, a telephone number, an age, and a sex, as shown for example in FIG. 3.

The broadcast station database 43 uses a table in which latitude/longitude information, a channel number, a broadcast station's name, or an ID unique to the station are associated to one another. When the broadcast station data base 43 receives positional information of the portable communication terminal 10 indicated by the latitude and longitude and the channel number, it has a function of replying a corresponding broadcast station's name or broadcast station ID.

The viewing/listening information database 44 accumulates viewing/listening information including the viewing/listening information and positional information transmitted from a user's portable communication terminal 10 registered as a monitor.

The viewing/listening information database 44 also has a function of generating viewing/listening rate information including a viewing/listening rate list, based on monitor information from the monitor information database 42, a broadcast station's name from the broadcast station database 43, or a broadcast station ID. Then, it provides the broadcast station 20 with the viewing/listening rate information generated.

Next, a monitor information registration process is explained. FIG. 4 is a sequence diagram showing an example of the monitor information registration process. In the monitor information registration process, the portable communication terminal 10 performs a process for monitor registration first (Step S101). Specifically, the portable communication terminal 10 accesses the program delivery server 41 in response to an operation of a user who has agreed with the monitor registration for a viewing/listening rate survey. Then, in order to request monitor registration, the portable communication terminal 10 transmits monitor registration request information including monitor information required for the monitor registration and input by the user.

If the monitor registration request information is received, and necessary information is included in the shown monitor information, the program delivery server 41 decides to make a monitor contract with the user of the portable communication terminal 10 for a certain period, and notify that to the portable communication terminal 10.

Subsequently, the program delivery server 41 provides the portable communication terminal 10 with the viewing/listening information transmitting program only for an viewing/listening rate survey (Step S102), and registers in the monitor information database 42 the monitor information about a monitor who has made the monitor contract (Step S103).

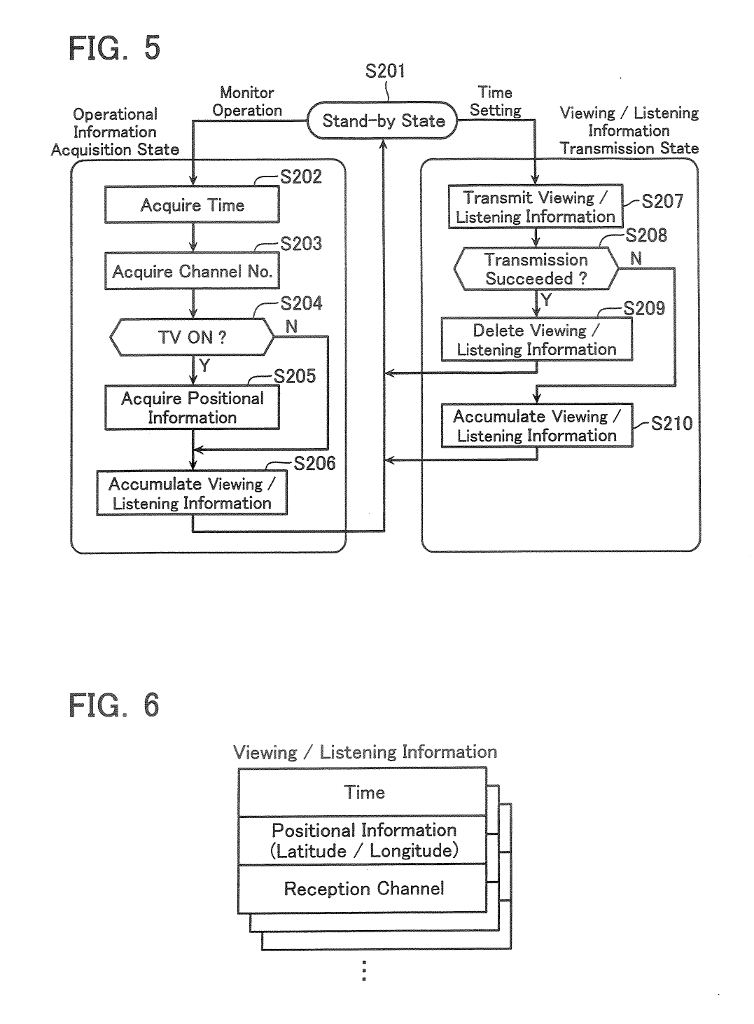

Next, the function of the viewing/listening data transmitting program operating on the portable communication terminal 10 is explained. FIG. 5 is a flowchart illustrating the example of the viewing/listening information transmitting process performed by the portable communication terminal 10 according to a viewing/listening information transmitting program.

The viewing/listening information transmitting program is a control program for saving in the portable communication terminal 10 the viewing/listening information including the time, the channel number, and the position information of the portable communication terminal 10, and for transmitting the viewing/listening information accumulated at a setup time to the viewing/listening information database 44.

In addition, a viewing/listening information transmitting program moves at a background like a listener program, and a user is not usually conscious of the operation.

The portable communication terminal 10 stays in a standby state about processes of accumulation and transmission of the viewing/listening information or the like, when TV broadcasting is not viewed and the operation about viewing and listening (a monitor operation) is not made, either (Step S201).

A monitor operation is an operation for a start, a termination, and a channel switching of TV program reception. If monitor operation is performed by the user of the portable communication terminal 10, it moves to an operation information acquisition state. In the operation information acquisition state, the portable communication terminal 10 acquires the present time first (Step S202). The time information may be directly acquired from portable communication terminal 10 inside, or may be acquired from outside, such as TV broadcast and a server. Next, the portable communication terminal 10 acquires a channel number (Step S203). This is performed in a TV tuner on the portable communication terminal 10. The channel number shows whether the TV broadcast is received. That is, when the operation for starting TV program reception or channel switching has been made, the portable communication terminal 10 judges that viewing/listening of TV broadcast concerning the channel number chosen after the operation has been started. When the operation for ending TV program viewing/listening or channel switching has been made, the portable communication terminal 10 judges that viewing/listening of TV broadcast concerning the channel number chosen before the operation ended.

When TV broadcast is viewed (Y of Step S204), the portable communication terminal 10 acquires position information about itself (Step S205). The position information is acquired, for example from the communication company server 30 as latitude and longitude. As the position information, the portable communication terminal 10 tries to obtain latitude and longitude from a GPS. If it is impossible, it obtains latitude and longitude of a communicatable communication base station.

When TV broadcast is not viewed (N of Step S204), the portable communication terminal 10 does not carry out acquisition of position information.

The portable communication terminal 10 saves the acquired time, the acquired channel number, and if any, the position information as the viewing/listening information at the storage device in the portable communication terminal (Step S206).

In addition, when TV broadcast is not viewed, the state where TV broadcast is not viewed shall be expressed by specifying the special number that is not usually used as a channel number. And the portable communication terminal 10 returns to a standby state (Step S201).

On the standby state (Step 201), the portable communication terminal 10 shifts to a viewing/listening information transmitting state, if the setup time arrives.

The setup time shall be specified beforehand by the viewing/listening rate survey company. The setup time is set in the viewing/listening information transmitting program sent from the program delivery server 41, and shall not be changed by a user of the portable communication terminal 10.

When the setup time arrives, the portable communication terminal 10 transmits the viewing/listening information accumulated in the portable communication terminal 10 as shown, for example in FIG. 6, to the viewing/listening information database 44 by E-mail (Step S207).

If it succeeds in transmission (Step S208), the portable communication terminal 10 deletes the transmitted viewing/listening information accumulated in the portable communication terminal 10 (Step S209). When transmission goes wrong, the portable communication terminal 10 maintains an accumulation state, without eliminating viewing/listening information (Step S210), returns to a standby state (Step S201), and transmits the remained viewing/listening information at the time of next viewing/listening information transmission together with the next viewing/listening information.

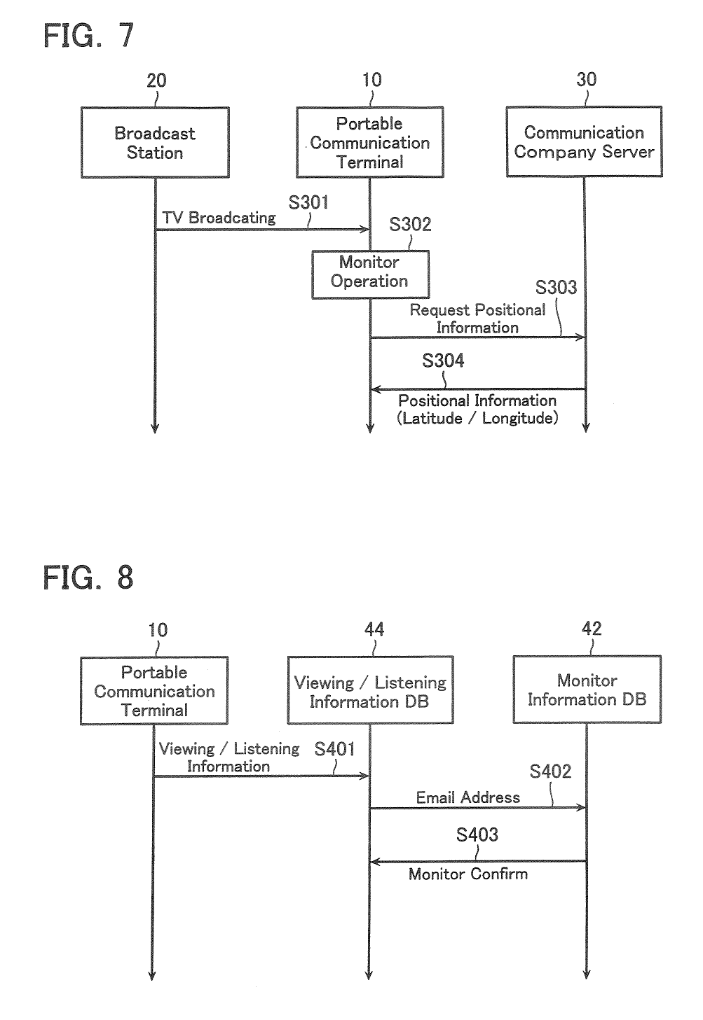

Next, a position information acquisition process when monitor operation is performed while TV broadcasting is received in the portable communication terminal 10 is explained. FIG. 7 is a sequence diagram showing an example of a position information acquisition process. The position information acquisition process corresponds to the process including Step S205 when the procedure is shifted to the operation information acquisition state in the flowchart of FIG. 5.

It is assumed that the broadcast station 20 broadly distributes the TV broadcast, and the portable communication terminal 10 receives the broadcast at any timing (Step S301).

If the portable communication terminal 10 judges that a monitor has performed a monitor operation (Step S302), it acquires time information and a channel number. If necessary, it requests the communication company server 30 for a position information acquisition of the portable communication terminal 10 (Step S303). The communication company server 30 transmits the position information of the portable communication terminal 10 to the portable communication terminal 10 according to an acquisition request of position information (Step S304). Then, the portable communication terminal 10 saves the viewing/listening information about TV broadcast it is receiving in the portable communication terminal 10.

Next, a viewing/listening information registration process in the viewing/listening information collecting system of this embodiment is explained. FIG. 8 is a sequence diagram showing an example of a viewing/listening information registration process. The viewing/listening information registration process corresponds to the process (Step S201, S207-S210) when the procedure is shifted to the viewing/listening information transmitting state in the flowchart of FIG. 5.

The portable communication terminal 10 transmits the information saved in the terminal 10 by E-mail to the viewing/listening information database 44 in a form as shown in FIG. 6 (Step S401). The viewing/listening information database 44 transmits to the monitor information database 42 the e-mail address of the received E-mail (Step S402). The monitor information database 42 confirms that the monitor is an authentic one, and the confirmation result is transmitted to the viewing/listening information database 44 (Step S403). On receiving a notice showing that the monitor is authentic, the viewing/listening information database 44 accumulates viewing/listening information with the e-mail address.

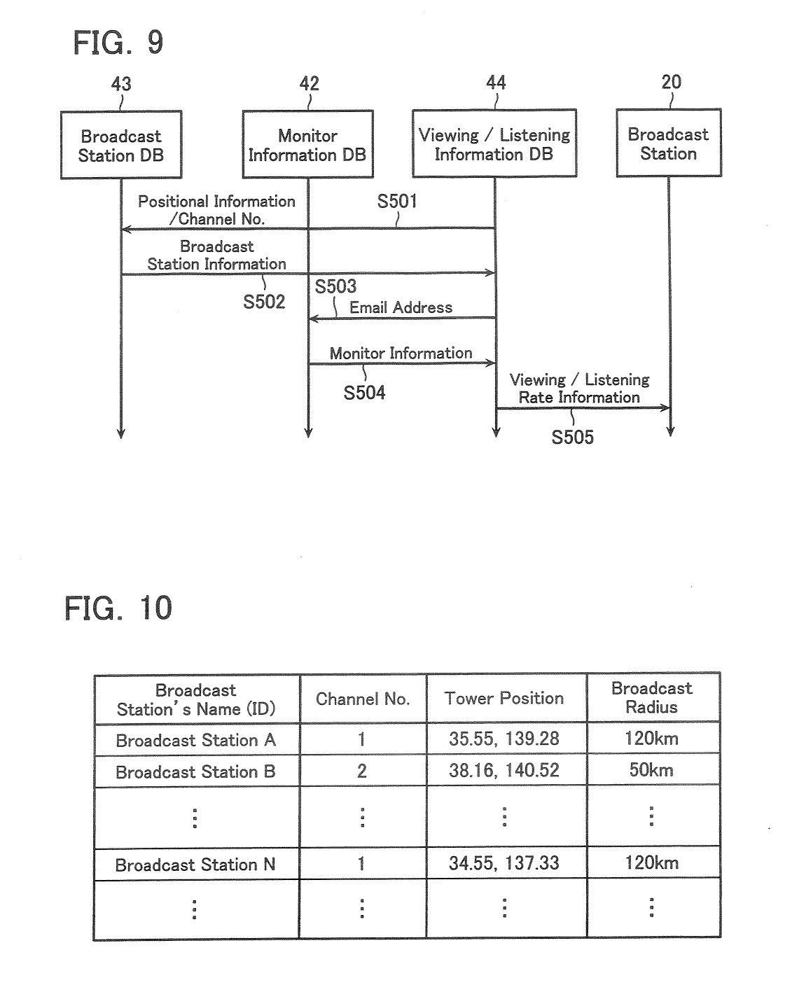

Next, a viewing/listening rate information transmitting process in the viewing/listening information collecting system of this embodiment is explained. FIG. 9 is a sequence diagram showing an example of a viewing/listening rate information transmitting process.

For example, if the time set beforehand arrives, such as one time a day, for example, 2:00 a.m., the viewing/listening information database 44 transmits the position information and the channel number in each collected viewing/listening information to the broadcast station database 43 (Step S501).

The broadcast station database 43 holds a table for specifying broadcast stations as shown for example in FIG. 10. Based on the received position information of the portable communication terminal 10 and the channel number, the broadcast station's name (broadcast station ID) of the broadcast station as an object of viewing/listening is specified. And the broadcast station information as a specified result is transmitted to the viewing/listening information database 44 (Step S502).

The table for specifying broadcast stations is a table including: a broadcast station's name (broadcast station ID); a channel number allocated to a broadcast station; a position of an electric-wave dispatching tower (a tower) of a broadcast station; and a broadcast radius being related to one another.

As to a channel number, the same number is sometimes allocated to different areas. In Step 502, The broadcast station database 43 searches the name (broadcast station ID) of the broadcast station that can be received at the position shown in the position information of the portable communication terminal 10. Among the searched result, the name of the broadcast station (broadcast station ID) given the received channel number is extracted. Thereby, the name of the broadcast station (broadcast station ID) that was an object of viewing/listening is specified.

On receiving the broadcast station information, the viewing/listening information database 44 transmits the e-mail address per viewing/listening information to the monitor information database 42 (Step S503) to obtain information on cooperators (monitors) for viewing/listening rate surveys, such as age and sex, from the monitor information database 42 (Step S504). The viewing/listening information database 44 analyzes the acquired information, and calculates the viewing/listening rates of each broadcast station per certain time zone, and the broadcast station 20 is provided with the viewing/listening rate information including a viewing/listening rate table incorporating the calculation result (Step S505).

As mentioned above, the portable communication terminal 10 is provided with the viewing/listening information transmitting program for generating and transmitting viewing/listening information. Since the viewing/listening information generated according to the viewing/listening information transmitting program is collected from the portable communication terminal 10, the broadcast station as an object of viewing/listening is specified from the collected viewing/listening information, and the viewing/listening result information is saved. Therefore, it is easy to collect viewing/listening information for computing the viewing/listening rate of the program provided from each broadcast station as a terrestrial digital broadcasting, from a portable communication terminal 10 having a viewing/listening function of terrestrial digital broadcasting.

Moreover, as described above, it has a structure to receive a position information of the portable communication terminal 10 and a channel number as an object of viewing/listening, and specify the broadcast station as an object of viewing/listening using a table for broadcast station specification. Therefore, even if a broadcasting is viewed and listened with a portable terminal device with portability and without a function of specifying usage position, the broadcast station as an object of viewing/listening can be specified, and it is possible to calculate a viewing/listening rate. That is, the broadcast station providing a program that was viewed and listened in the portable communication terminal 10 can be specified easily and correctly.

Moreover, as described above, it calculates a viewing/listening rate per broadcast station at a certain time interval based on plurality pieces of saved viewing/listening information or the like, and transmits a viewing/listening rate table showing a list of the viewing/listening rates to the broadcast station 20 through a communication network. Therefore, a viewing/listening rate per broadcast station can be computed, and each broadcast station can be provided with the viewing/listening rate table showing the list of viewing/listening rates.

### The Second Embodiment

In the system of the first embodiment mentioned above, the remuneration delivery to the monitor of an viewing/listening rate survey is not employed. However, this remuneration delivery may be automated in the system. In this case, remuneration (privilege) is delivered using an electronic medium such as electronic money and an E-mail.

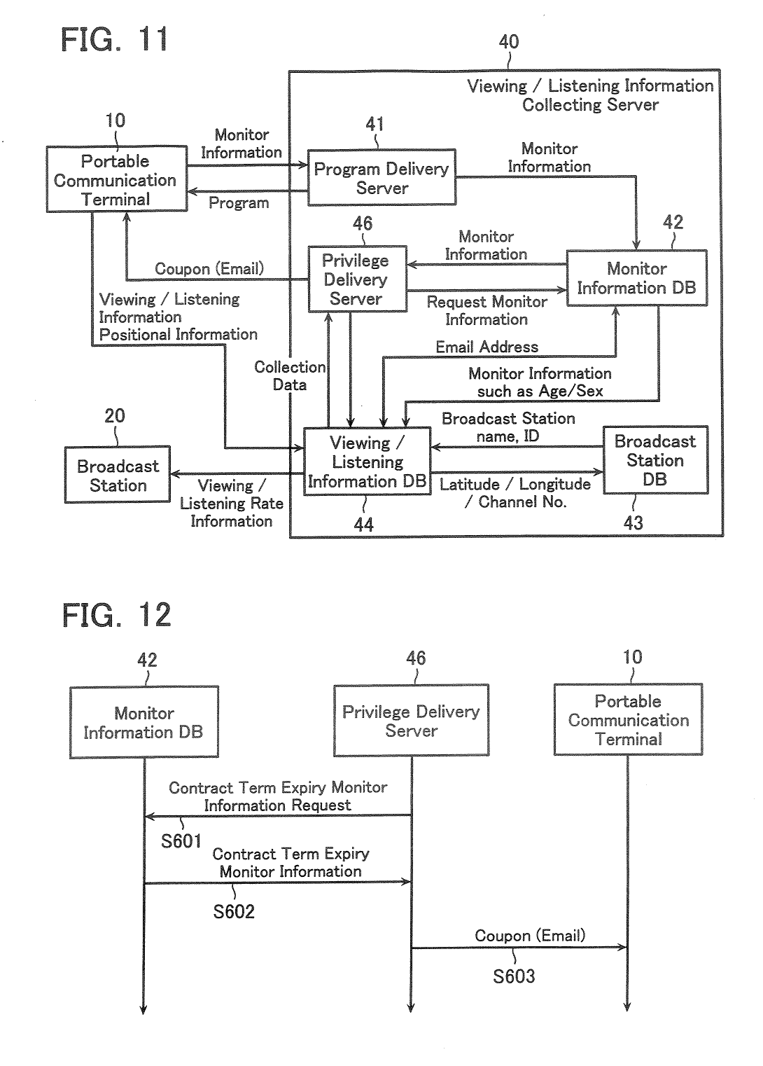

FIG. 11 is a block diagram showing an example of the viewing/listening information collecting system including a privilege delivery server 46 according to the second embodiment. FIG. 12 is a sequence diagram showing an example of a privilege delivery process.

As shown in FIG. 12, the privilege delivery server 46 requests the monitor information database 42 for the monitor information about a monitor whose contract term ended, at a specific timing, such as one time per month (Step S601).

The monitor information database 42 transmits to the privilege delivery server 46 the monitor information about a monitor whose contract term ended (Step S602) The privilege delivery server 46 transmits the E-mail including the remuneration (privilege) in an electronic medium (such as electronic money and a coupon), to the e-mail address of the acquired monitor information (Step S603). Thus, a certain privilege is given as remuneration to the monitor whose contract term ended.

As mentioned above, a user who will be given a privilege (user whose monitor contract ended) is determined from users of the portable communication terminal 10 registered as monitors, and the privilege information showing a certain privilege (such as electronic money, a coupon or the like) is transmitted to the portable communication terminal 10 used by the user determined to receive the privilege. With this arrangement, it is possible to award a certain privilege such as a coupon to a user registered as a monitor. This may be a motivation for monitor registration, and it is expected that many users will agree with a monitor registration request.

Although an e-mail address is used to specify an individual in the above-mentioned embodiments, information other than an E-mail, such as an individual ID may be used to specify an individual. In this case, the individual ID is an unique number allocated to a program. When the program is downloaded to the portable communication terminal 10, the unique number is allocated to the program. Alternatively, the individual ID is an unique number allocated to the monitor himself or herself. It is allocated to him or her when a viewing/listening rate survey contract is made. The unique number cannot be changed by the owner of the portable communication terminal 10.

Moreover, in the embodiment mentioned above, the owner of the portable communication terminal 10 who has agreed with the viewing/listening rate survey performs registration of monitor information in the program delivery server. However, when the owner made a contract in advance at the time of an viewing/listening rate survey request, and monitor information has already been acquired, registration of the monitor information in the program delivery server may be simplified. That is, all it needs is information that can specify monitors, such as an e-mail address or an individual ID.

Moreover, in the above-described embodiment, an viewing/listening rate survey company uses the Basic Resident Register to determine monitors of an viewing/listening rate survey. Instead of this, as long as the portable communication terminal 10 has a telephone function, a request may be made by making a phone call to numbers generated at random. In this case, the telephone number is used for specifying an individual in the monitor registration information used in the program delivery server.

In the example described above, a viewing/listening rate survey company selects a telephone number generated at random for determining monitors of an viewing/listening rate survey, makes a phone call, and makes a request. The request may be made through a website. For example, a monitor is invited at the website of an viewing/listening rate survey company, and they makes a contract there. In this case, restrictions in number (for example, 10,000 people) are prepared per area (Kanto, Kansai, etc.) to balance the number of the cooperator for the viewing/listening rate survey per area. For example, the monitors may be determined on a first-come-first-out basis per resident area of the monitors, or by a lottery.

Furthermore, after inviting people to the website of an viewing/listening rate survey company, monitors may be selected from the people in consideration of the balance of monitors (sex, age, etc.) and numbers per area. Thereafter, requests of an viewing/listening rate survey may be made to the selected monitor candidates by E-mail or the like.

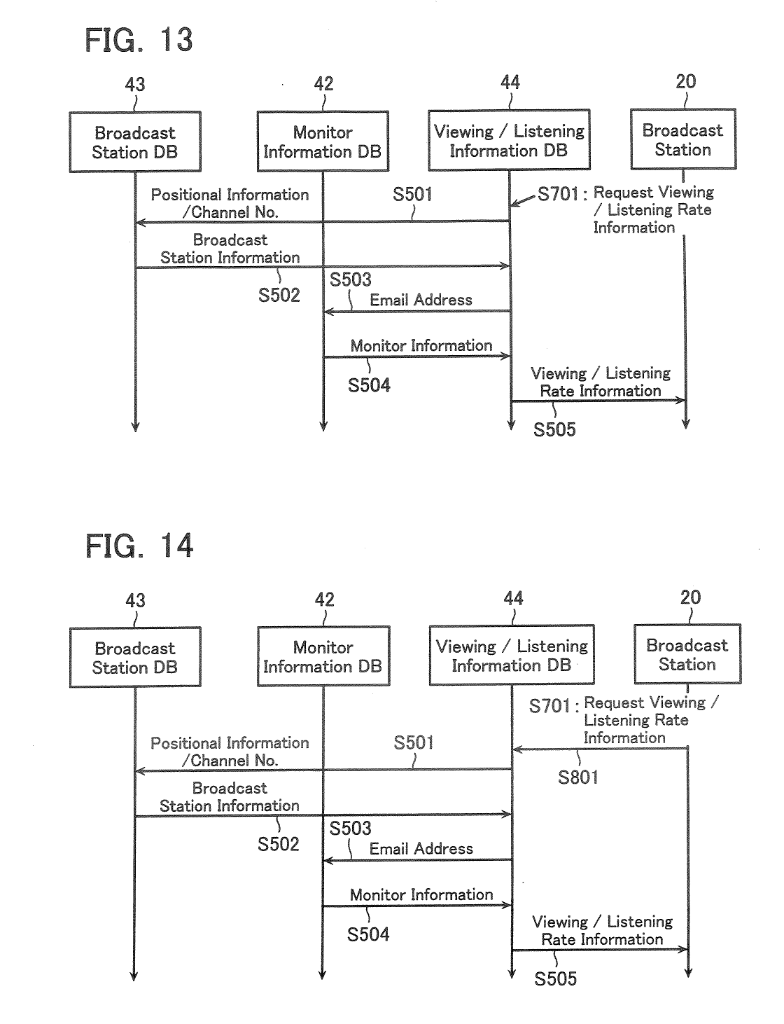

Moreover, in the embodiments mentioned above, viewing/listening rate information is provided to the broadcast station 20 at the setup time. However, for example, as shown in FIG. 13, the viewing/listening rate information may be provided to the broadcast station 20 when an viewing/listening rate survey company requests viewing/listening rate information to the viewing/listening information database 44 (Step S701).

In the above-described embodiment, the viewing/listening rate survey company transmits a request of the viewing/listening rate information to the viewing/listening information database 44. However, as shown for example in FIG. 14, the broadcast station 20 may directly transmit a request of viewing/listening rate information to the viewing/listening information database 44 (Step S801).

Moreover, in the embodiments mentioned above, the viewing/listening rate per broadcast station is output from the viewing/listening information database 44. The viewing/listening rate per channel owned by a broadcast station—not per broadcast station—may be output. For example, with a terrestrial digital broadcasting technology, broadcasting of three channels is possible in a zone for one channel of analog broadcasting. One broadcast station is technically able to broadcast three channels simultaneously. In this situation, the viewing/listening rate for every channel is measurable.

On acquiring and accumulating viewing/listening information, channel information and position information might be the same (coincidence) as those obtained in the last acquisition process, among the viewing/listening information shown in FIG. 6 (This is not mentioned in the explanation of the above-described embodiments). In such a case, by using a predetermined sign showing being the same as those of the last acquisition, data volume can also be made small.

Moreover, in the embodiments mentioned above, position information is obtained every time by the portable communication terminal 10. However, this place a considerable burden to traffic. Therefore, the position information may be stored in the portable communication terminal 10, and the user of the portable communication terminal 10 may request acquisition of the position information when it becomes necessary. That is, when the user of the portable communication terminal 10 receives broadcast for the first time, position information is acquired and saved at the portable communication terminal 10. And the saved position information is used thereafter. In addition, when the user of the portable communication terminal 10 moves to a different broadcast area, the user of the portable communication terminal 10 requests position information acquisition by himself or herself, and updates the position information.

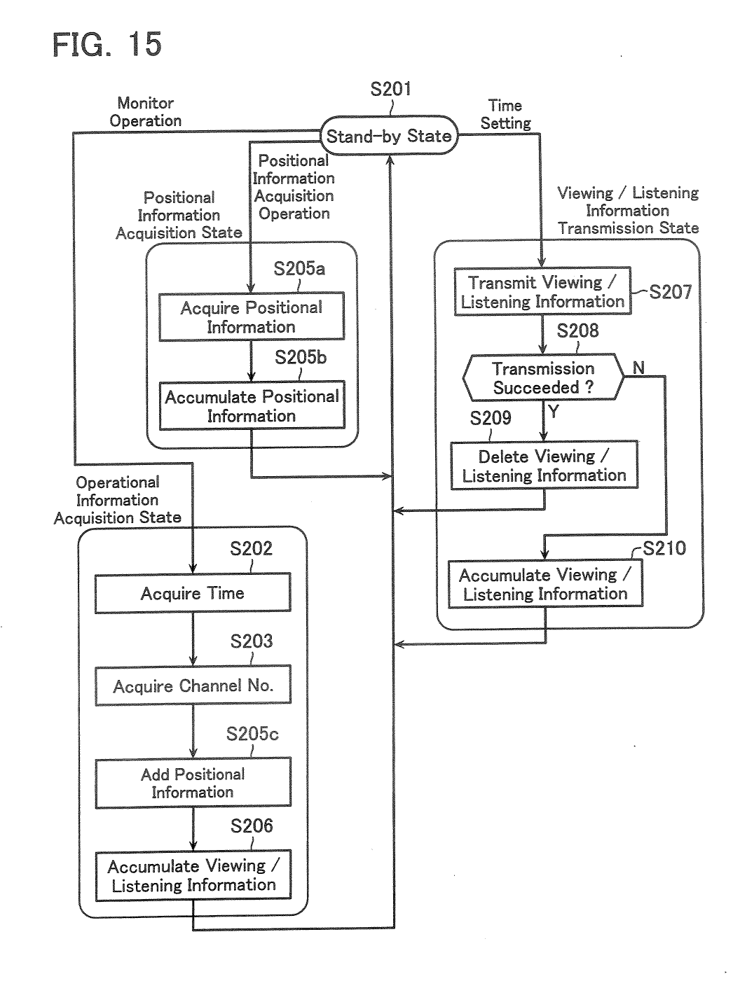

As shown specifically in FIG. 15 for example, the portable communication terminal 10 shifts from a standby state (Step 201) to the position state acquisition state, if position information acquisition operation is performed by a user.

The position information will be accumulated in the portable communication terminal 10 (Step S205a, S205b), and it returns to a standby state (Step S201).

When viewing/listening operation (monitor operation) such as channel switching or the like is performed by a user at a standby state (Step S201), the portable communication terminal 10 shifts to the operation information acquisition state. After acquiring time and a channel number (Step S202, S203), the position information accumulated separately is added (Step S205c). And viewing/listening information as shown in FIG. 6 is formed and saved.

By performing such a process, it becomes unnecessary to acquire position information every time it receives TV broadcasting. Therefore, the load of the traffic relating to acquisition of position information can be reduced.

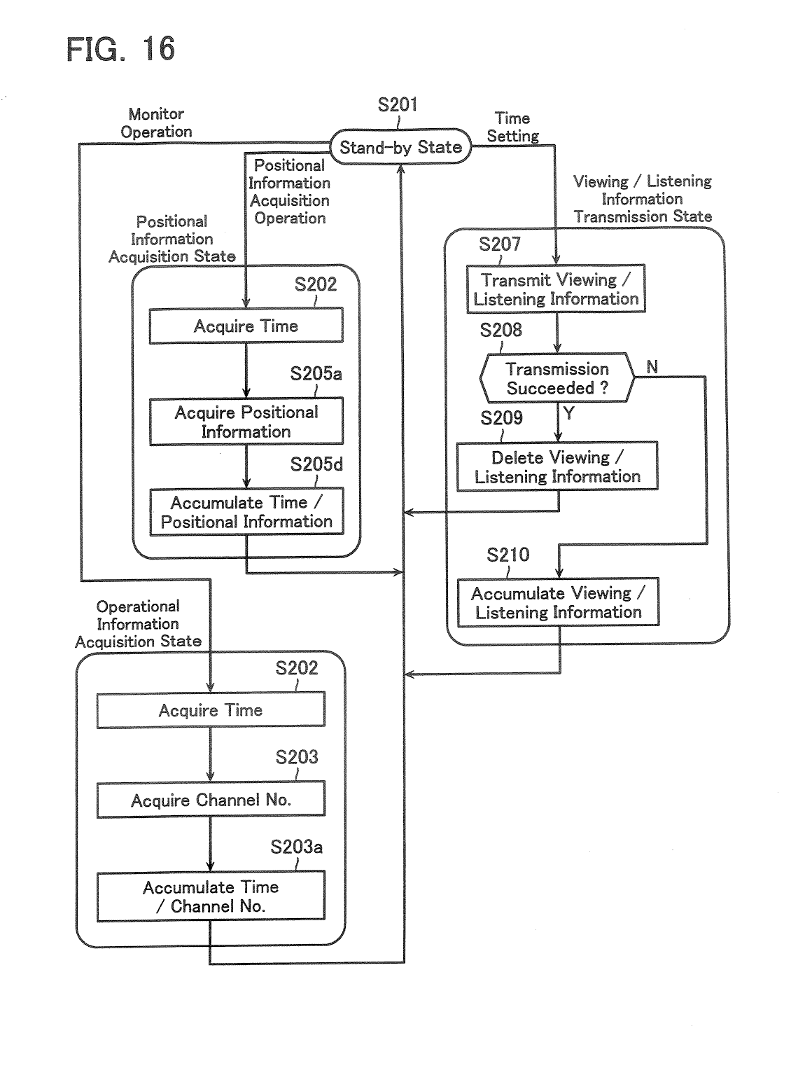

Moreover, a configuration shown in FIG. 16 serves to reduce the capacity of viewing/listening information, by changing the composition of the viewing/listening information, in addition to the reduction of traffic load.

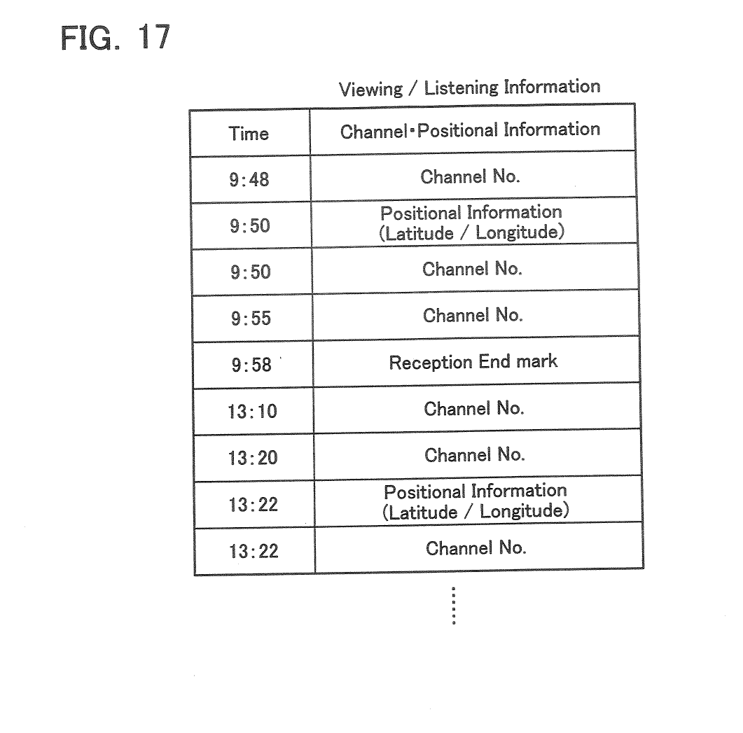

The composition of the viewing/listening information in this case is shown, for example in FIG. 17.

In the example shown in FIG. 16, if position information acquisition operation is performed by a user, the procedure shifts to the position information acquisition state. After acquiring time and position information (Step S202, S205a), time and position information are saved as viewing/listening information (Step S205d). Then, the procedure returns to a standby state (Step S201).

If viewing/listening operation such as channel switching or the like is performed by a user at a standby state, the procedure shifts to the operation information acquisition state. After acquiring the time and the channel number (Step S202, S203), the time and the channel number are saved as viewing/listening information (Step S203a). Then, the procedure returns to a standby state (Step S201).

Moreover, in the embodiments mentioned above, when the portable communication terminal 10 judges that an operation about viewing/listening of TV broadcasting (channel change or the like) has been made in the portable communication terminal 10 according to the viewing/listening information transmitting program, all the channel numbers or the like are saved.

However, on choosing a TV program to be viewed, a viewer of TV broadcasting tends to change channels one after another, see them briefly, and determine a channel (zapping).

In this case, storing all the operation causes the amount of information to be increased. Therefore, it is possible to judge that a viewer is viewing and listening to a program if no operation has been made for a certain period (for example, 30 seconds). Then, the channel number or the like may be stored.

Moreover, in the embodiments mentioned above, when the portable communication terminal 10 judges that an operation about viewing and listening of TV broadcasting has been made (channel change etc.) in the portable communication terminal 10, according to the viewing/listening information transmitting program, the channel number or the like is saved. However, it may be saved at a predetermined time (for example, five minutes past every hour), or per predetermined time interval (for example, 1 minute).

Furthermore, although the embodiments mentioned above mainly explained the case where the viewing/listening rate of TV broadcasting is computed. However it is needless to say that the present invention can be similarly applied to any broadcasting, especially a radio broadcasting or the like. When computing the viewing/listening rate of a radio broadcasting, the broadcast station 20 may include a broadcast station for a radio broadcasting, and the portable terminal 10 has a function of receiving a radio signal. Being structured in this way, viewing/listening information for computing a viewing/listening rate of a radio program provided from each broadcast station as a terrestrial digital broadcasting is easily collectable from portable communication terminals having a radio signal receiving function.

What is claimed is:

1. A viewing/listening information collecting server collecting viewing/listening information indicating a viewing/listening mode of terrestrial digital broadcasting, from a portable terminal device enabled to receive terrestrial digital broadcasting from a broadcast station, comprising:
a program providing unit providing the portable terminal device with a viewing/listening information transmitting program for generating and transmitting the viewing/listening information;
a receiving unit receiving through a communication network the viewing/listening information generated by the viewing/listening information transmitting program in the portable terminal device;
a broadcast station specification unit specifying the broadcast station of the broadcast received at the portable terminal device based on the viewing/listening information received at the receiving unit; and
a storing unit storing viewing/listening result information including monitor information provided to the portable terminal device, the viewing/listening information received at the receiving unit, and the broadcast station specified by the broadcast station specification unit.

2. The viewing/listening information collecting server according to claim 1, wherein
the viewing/listening information includes selected channel information indicating a selected channel selected in the portable terminal device among channels to be selected as a broadcast to be received, position information indicating current position of the portable terminal device, and time information indicating current time, and
the broadcast station specification unit specifies a broadcast station according to a selected channel indicated in the selected channel information and a current position indicated in the position information among the viewing/listening information.

3. The viewing/listening information collecting server according to claim 1, wherein
the broadcast station includes a television broadcast station, and
the portable terminal device has a function of receiving a TV signal for receiving a television broadcasting.

4. The viewing/listening information collecting server according to claim 1, wherein
the broadcast station includes a radio broadcast station, and
the portable terminal device has a function of receiving a radio signal for receiving a radio broadcasting.

5. The viewing/listening information collecting server according to claim 1, further comprising:
a calculation unit calculating a viewing/listening rate per broadcast station at a certain interval based on a plurality pieces of viewing/listening result information stored in the storing unit, and
a first transmitting unit transmitting through a communication network to each of the broadcast station a viewing/listening rate list indicating a list of the viewing/listening rates calculated by the calculation unit.

6. The viewing/listening information collecting server according to claim 1, further comprising:
a determination unit determining a user as a privilege receiver among users of the portable terminal devices registered as monitors; and
a second transmitting unit transmitting privilege information indicating a certain privilege to the portable terminal device used by the user decided as a privilege receiver in the determination unit.

7. A viewing/listening information collecting method collecting viewing/listening information indicating a viewing/listening mode of terrestrial digital broadcasting, from a portable terminal device enabled to receive terrestrial digital broadcasting from a broadcast station, comprising:
a program providing step providing the portable terminal device with a viewing/listening information transmitting program for generating and transmitting the viewing/listening information;
a receiving step receiving through a communication network the viewing/listening information generated by the viewing/listening information transmitting program in the portable terminal device;
a broadcast station specification step specifying the broadcast station of the broadcast received at the portable terminal device based on the viewing/listening information received at the receiving step; and
a storing step storing viewing/listening result information including monitor information provided to the portable terminal device, the viewing/listening information received at the receiving step, and the broadcast station specified by the broadcast station specification step.

8. The viewing/listening information collecting method according to claim 7, wherein
the viewing/listening information includes selected channel information indicating a selected channel selected in the portable terminal device among channels to be selected as a broadcast to be received, position information indicating current position of the portable terminal device, and time information indicating current time, and
the broadcast station specification step specifies a broadcast station according to a selected channel indicated in the selected channel information and a current position indicated in the position information among the viewing/listening information.

9. The viewing/listening information collecting method according to claim 7, further comprising
a calculation step calculating a viewing/listening rate per broadcast station at a certain interval based on a plurality pieces of viewing/listening result information stored in the storing step, and
a first transmitting step transmitting through a communication network to each of the broadcast station a viewing/listening rate list indicating a list of the viewing/listening rates calculated by the calculation step.

10. The viewing/listening information collecting method according to claim 7, further comprising
a determination step determining a user as a privilege receiver among users of the portable terminal devices registered as monitors, and
a second transmitting step transmitting privilege information indicating a certain privilege to the portable terminal device used by the user decided as a privilege receiver in the determination step.

11. A viewing/listening information transmitting program allowing a portable terminal device enabled to receive terrestrial digital broadcasting from a broadcast station to generate and transmit viewing/listening information indicating a viewing/listening mode of terrestrial digital broadcasting, the program being configured to allow the portable terminal device to execute:
a generating step generating viewing/listening information that may specify a broadcast station of a broadcast received therein; and
a transmitting step transmitting through a communication network the viewing/listening information generated in the generating step.

12. The viewing/listening information transmitting program according to claim 11, wherein
the viewing/listening information includes selected channel information indicating a selected channel selected in the portable terminal device among channels to be selected as a broadcast to be received, position information indicating current position of the portable terminal device, and time information indicating current time.
